(19) United States
(12) Patent Application Publication
(10) Pub. No.: US 2008/0297763 A1
(43) Pub. Date: Dec. 4, 2008

(54) SINGLE AXIS SCANNING PIV SYSTEM AND METHOD

(76) Inventors: Jean Herzberg, Boulder, CO (US); Hyoung-Bum Kim, Seoul (KR)

Correspondence Address: LATHROP & GAGE LC, 4845 PEARL EAST CIRCLE, SUITE 300, BOULDER, CO, 80301, US

(21) Appl. No.: 12/059,989

(22) Filed: Mar. 31, 2008

Related U.S. Application Data
(60) Provisional application No. 60/909,308, filed on Mar. 30, 2007.

(51) Int. Cl. G01P 3/36

(52) U.S. Cl. 356/28

(57) ABSTRACT

A single axis scanning PIV system, comprising a laser for generating a laser beam, optics for scanning the laser beam through particles in motion, an optical imager for capturing, images of the particles due to interaction between the laser beam and the particles, and a processor for implementing an algorithm that determines velocity information of the particles based on the images.

### RELATED APPLICATIONS

This application claims priority of U.S. Provisional Application Ser. No. 60/909,308 filed Mar. 30, 2007, the content of which is hereby incorporated into this application by reference.

### BACKGROUND

Conventional particle image velocimetry (PIV) requires a significant angle between the illumination plane and the viewing axis.

### SUMMARY

Single axis scanning particle image velocimetry (PIV) disclosed herein views the entire field to be viewed with minimal image distortion. In-plane scanning is used to assemble the particle images. Appendix A provides, for disclosure purposes, exemplary and non-limiting detail of single axis scanning PIV according to an embodiment.

### BRIEF DESCRIPTION OF THE FIGURES

FIG. 1 shows a single axis scanning PIV system, in an embodiment.

FIG. 1A shows a single axis scanning PIV system, in an embodiment.

FIG. 2 shows a timing diagram of the single axis scanning PIV system of FIG. 1.

FIG. 3 is a flowchart illustrating one exemplary method embodiment for single axis scanning PIV, in an embodiment.

### DETAILED DESCRIPTION OF THE FIGURES

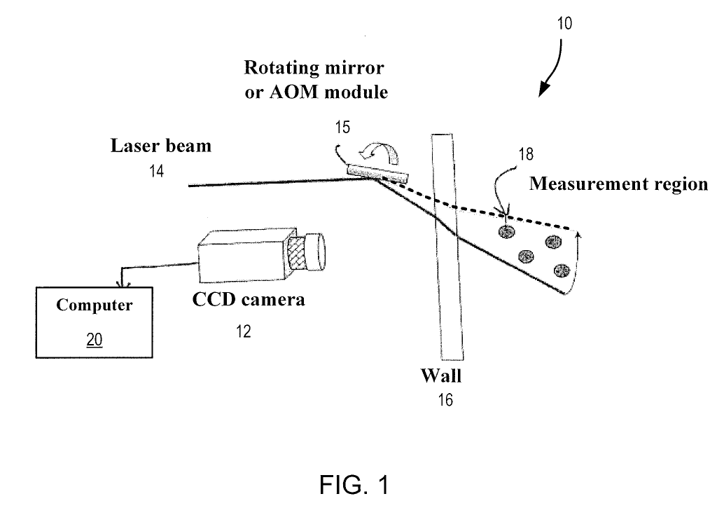

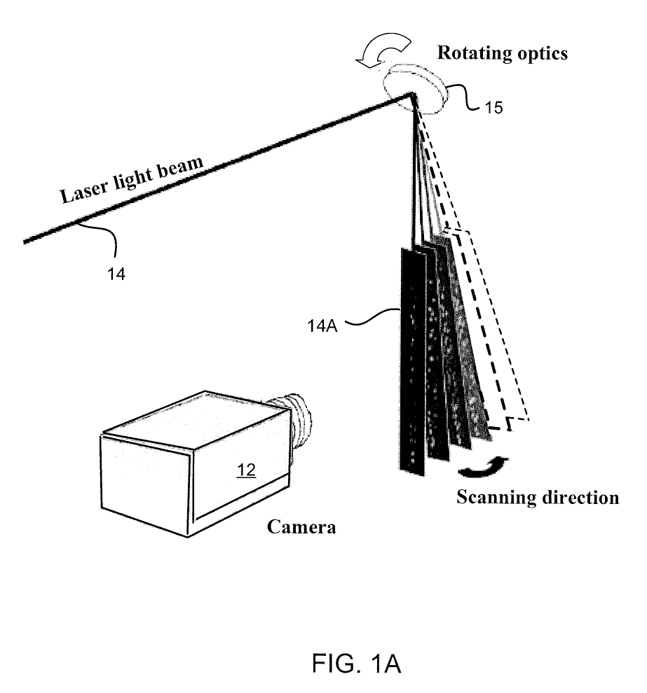

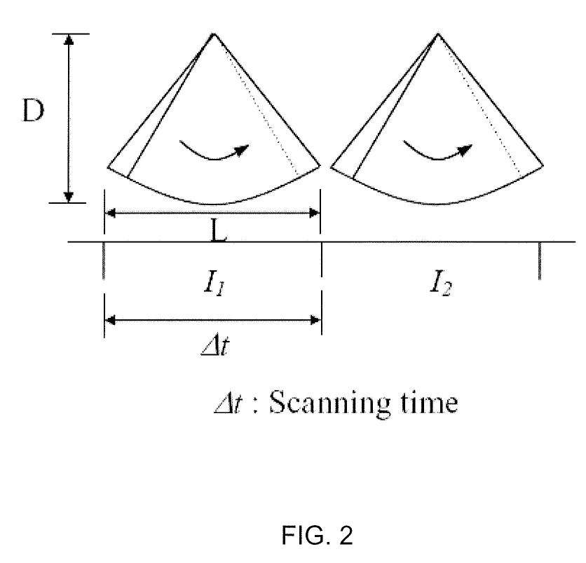

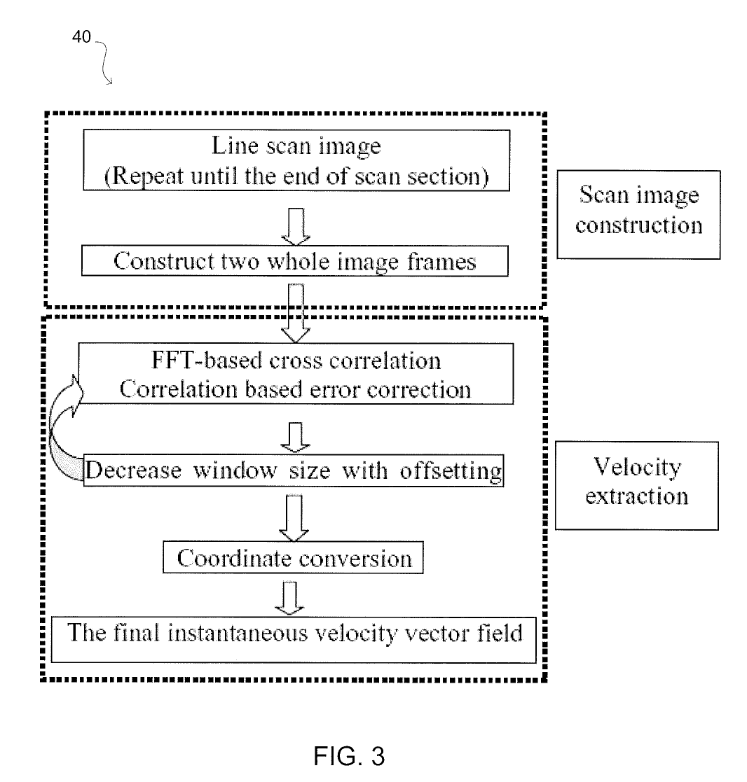

A single axis scanning PIV system 10 is shown in FIG. 1; it includes an optical imager 12 (e.g., a camera), a laser 14, scanning optics 15 and a wall 16 (e.g., part of a chamber) transmissive to laser 14. A computer 20 (e.g., a processor connected with or to imager 12) processes data imaged by imager 12 to measure velocity of particles 18 viewed by optical imager 12. An alternative single axis scanning PIV system 30 is shown in FIG. 1A; in this embodiment, laser 14 is formed into a fan 14A, which also is scanned by optics 15 through particles 18. The increased width of fan 14A may provide more detailed information on particles traveling through fan 14A at any one time. FIG. 2 shows a timing diagram of particles passing through the scanned laser beam 14 of FIG. 1. FIG. 3 shows a process 40 that may be implemented by computer 20, FIG. 1, for example, to extract velocity from particles that interact with laser 14 when viewed by imager 12.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A single axis scanning PIV system, comprising:
a laser for generating a laser beam;
optics for scanning the laser beam through particles in motion;
an optical imager for capturing, over time, images of the particles due to interaction between the laser beam and the particles; and
a processor for implementing an algorithm that determines velocity information of the particles based on the images.

2. The system of claim 1, the algorithm accounting for optical geometry of a wall between the imager and particles.

3. The system of claim 1, the algorithm comprising one or more of:
performing a FFT-based cross correlation; decreasing window size with offsetting;
coordinate conversion; and determining a vector field.
